(19) United States
(12) Patent Application Publication
(10) Pub. No.: US 2019/0084714 A1
(43) Pub. Date: Mar. 21, 2019

(54) DEVICE FOR PRINTING CLOSURES OF CLOSED CONTAINERS

(71) Applicant: KRONES AG, Neutraubling (DE)

(72) Inventor: Peter LINDNER, Langquaid (DE)

(21) Appl. No.: 16/083,275

(22) PCT Filed: Dec. 9, 2016
(86) PCT No.: PCT/EP2016/080378

§ 371 Date: Sep. 7, 2018

(30) Foreign Application Priority Data
Mar. 8, 2016 (DE) 10 2016 203 722.6

(51) Int. Cl. B65C 9/46

(52) U.S. Cl. CPC B65C 9/46; B41J 11/002

(57) ABSTRACT

A device for printing closures of closed containers, comprising a transport section for transporting the containers, wherein a detection unit and a printing unit for printing the closure of a container are arranged behind one another in the transport direction and the detection unit can individually determine the position of the closure transversely with respect to the transport direction for each container and can transmit a signal which is indicative of the position to a control unit which is assigned to the detection unit and the printing unit. The control unit is designed to control the printing unit to apply printing ink to the closure in order to print the closure according to its position. Also disclosed is a corresponding method.

The present invention refers to a device and a method for printing closures of closed containers.

### PRIOR ART

It is known from the prior art that closures of containers are provided with print images.

With respect to containers equipped with labels it is known from DE 10 2006 019 441 A1 that the imprint is applied to the closure on the basis of the random orientation (rotation) of the label provided on the container. The position of the containers, which are for example transported in a transport starwheel, is known at any time and only their rotational position or the position of the label relative to the printing head, which is to apply the image to the closure, has to be determined for each container.

Furthermore, it is known from WO 2015/011663 A1 that closures of containers are printed taking into account the distance of the containers from one another in a transport device. For this purpose the infeed of each container into the corresponding printing station is determined by a light barrier and the printing unit is prompted according to this position to print the closure of the container.

The known methods and devices have in common that they always determine the position of the container as a whole and thus also the position of the closure on the basis of the determination of the position of a label or a part of the container and, depending on this, the printing device is controlled to print the closure of the container.

Especially in the case of containers made of glass, which are for example provided with a crown cap, the production process of the glass bottles may cause minor deviations in the shape of the actual containers from the ideal shape, so that the containers produced are not rotation-symmetrical. As a consequence, the printing of the closure can be very flawed.

Corresponding problems may also arise in containers made of plastics, particularly PET.

### Object

Hence, starting from the known prior art, the object to be solved consists in indicating a method and a device used for printing closures of closed containers, which allow a reliable and correct printing of the closure.

### Solution

This object is solved by the device for printing closures of closed containers according to claim 1 and by a corresponding method according to claim 9. Advantageous developments of the invention are included in the sub-claims.

According to the invention the device for printing closures of closed containers comprises a transport section for transporting the containers, wherein a detection unit and a printing unit for printing the closure of a container are arranged one behind the other in transport direction, wherein the detection unit can individually determine the position of the closure transversely with respect to the transport direction for each container and can transmit a signal indicative of the position to a control unit which is assigned to the detection unit and the printing unit, wherein the control unit is configured to control the printing unit to apply printing ink to the closure in order to print the closure, depending on the position.

The containers may particularly be bottles, here preferably bottles of glass or plastics, in particular PET. Coated containers may also be printed with the device. The coated containers may also be bottles made of the said or other materials. In particular, containers provided with labels can be printed.

Basically, all containers that are provided with a detachable closure (crown cap, cork or screw cap or the like) can be printed with the device, i.e. the closure can be printed. The closures may be metal or plastic closures. Closures that comprise both metallic components and components consisting of plastics such as PET are also conceivable. Furthermore, containers which are closed with a closure consisting of natural, specifically organic, materials or comprising such materials can also be printed with the device. Closures which are additionally provided with a seal, label or a metal foil, as is for instance common in the case of sparkling wine bottles, wine bottles or beer bottles, can also be printed. Rather large closures, such as screw caps of yoghurt cups, can also be printed.

Since for the control of the printing unit the position of the closure is determined at least transversely with respect to the transport direction for each container, minor deviations in the shape of the container are compensated and the closure can be printed correctly. Moreover, since the deviations of each container from the ideal shape may differ from container to container, reliable printing of each container is ensured by the determination of said position in each individual container.

In one embodiment, the control unit for the purpose of controlling the ejection of the printing ink is configured to adapt a print image stored in a memory for the closure on the basis of software to the position to obtain a print image to be applied and to control the printing unit on the basis of the print image to be applied for the ejection of the printing ink.

In the final analysis this means that the print image to be applied is adapted first digitally, i.e. software-based, to the position with the help of the control unit, which may for instance be configured as a computer or the like. This regards especially the position at which the print image is output by the printing unit using printing ink. To this end the stored print image or the information pertaining thereto, which is transferred to the printing unit and effects the control of the individual nozzles of the printing unit, can be changed such that the position at which the printing ink forming the print image is ejected out of the printing unit corresponds to the position of the closure on the container.

With this embodiment the printing unit can be configured to be stationary, i.e. unmovable relative to the transport section, and can nevertheless ensure a reliable printing of the print images on the closures. Since the software-based modification of the print image can be carried out faster than a shift of the printing unit relative to the transport section, the throughput with which the closures of the containers can be printed can be increased with this embodiment at the same time.

In a further embodiment it is provided that the printing unit is a digital printing unit and comprises a printing head with a printing area whose width transverse to the transport direction is greater than the diameter of a closure to be printed and at most equal to the width of the transport section. Thus, virtually any deviations of the containers from their ideal shape can be compensated and the closures can be printed correctly without the need for additional means for moving the printing unit.

Furthermore, the printing unit can be configured to be stationary.

Moreover, it may be provided that the detection unit comprises an optical unit for taking an image, an illumination device for illuminating at least a part of a container transported in the transport section and an optical body assigned to the optical unit for diverting rays of the illumination device reflected from the container into the optical unit. Optionally, information on the container which is additionally required for the printing of the closure of the container may also be taken into consideration.

In a development of this embodiment, the illumination device can emit light in the visible range and the optical body has a refractive index greater than 1 or consists of reflective material. Thus, characteristics of the container that are visible to the final consumer can be used in the determination of the print image to be applied to the closure. This can increase the product's acceptance.

The optical body can here be arranged concentrically to the optical unit and comprise an aperture whose center point lies on the optical axis of the optical unit. Thus, on the one hand, information on the container that is of relevance to the printing of the closure can be passed on to the optical unit, and simultaneously the position of the actual closure through the opening without any possibly disturbing optical effects.

Furthermore, it may be provided that the control unit is configured to rotate a print image stored in a memory for the closure on the basis of software, depending on the reflected light, to produce a print image to be applied depending on the position of a label on the container and to control the printing unit on the basis of the print image to be applied for the ejection of the printing ink. The device can thus not only ensure that the closure is completely provided with a print image at all, but also that this print image is correctly aligned relative to further features provided on the container or container closure, such as label, embossings, recessed grips or press seams, swing stopper position, geometry of the closure or elevations and/or recesses in the form of symbols, for example.

In the method according to the invention for printing closures of closed containers, the containers are transported along a transport section and a detection unit determines the position of the closure transversely with respect to the transport direction for each container, wherein further a printing unit applies printing ink for producing a print image to the closure, wherein the ejection of the printing ink is controlled by a control unit on the basis of a signal which is output by the detection unit and is indicative of the position of the closure transversely with respect to the transport direction. It is thereby ensured that the whole print image is applied to the closure both correctly and completely.

In one embodiment the detection unit determines the position optically.

Furthermore, it may be provided that the containers are transported in a disordered manner at least with respect to their position transversely with respect to the transport section. Since the position of the closure transversely with respect to the transport section is determined at any rate in order to print the closure, devices which ensure a movement of the containers as exactly as possible in a direction transverse to the transport direction can thus be omitted and the throughput of containers can optionally be increased.

Furthermore, it may be provided that for the control of the ejection of the printing ink a print image stored in a memory for the closure is adapted on the basis of software to the position to obtain a print image to be applied and the printing unit is controlled on the basis of the print image to be applied for the ejection of the printing ink. The software-based manipulation of the print image can sometimes be carried out faster than the changing of the position of the printing unit itself by mechanical means, so that even at a high throughput or high speed of the containers to be printed it is possible to adapt the ejection of the printing ink for each container individually.

In a further embodiment, it is provided that the closed containers to be printed comprise a label and an illumination device illuminates the containers at least in an area which comprises at least a part of the label and light reflected from the area is supplied through an optical body to an optical unit of the detection unit. Thus it is possible to use not only the position of the closure, but also additional features of the container, in particular the position of the label, for the determination of the print image to be applied to the closure.

In a development of this embodiment, the printing unit is controlled by the control unit on the basis of the reflected light supplied to the detection unit for the ejection of the printing ink. Hence, the print image or design can be applied depending on the label, here particularly the contents of the label, to the container.

In a development of this embodiment, a print image for the closure which is stored in a memory is rotated software-based, depending on the reflected light, scaled in size or adapted to the geometry of the closure to produce a print image to be applied depending on the position of the label on the container, and the printing unit is controlled based on the print image to be applied for the ejection of the printing ink. Thus, the print image is applied, oriented with respect to the label, to the closure.

### BRIEF DESCRIPTION OF THE FIGURES

FIG. 1 shows a schematic representation of a device for printing closures according to one embodiment,

FIG. 2a+b show schematic representations of the shape of a closed container in comparison with the ideal shape,

FIG. 3 shows a schematic representation of an embodiment of the method for printing the closure,

FIG. 4 shows a schematic representation of a device for printing closures according to a further embodiment,

FIG. 5 shows a schematic representation of a further embodiment of the method for printing the closure.

### DETAILED DESCRIPTION

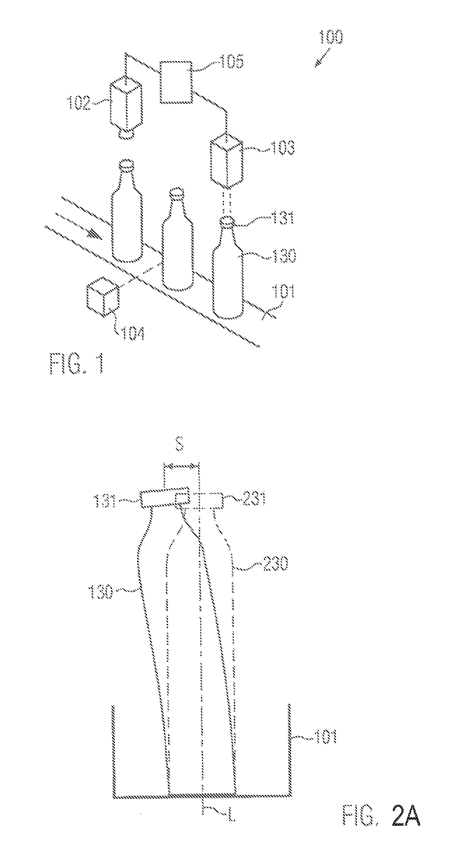

FIG. 1 shows a device 100 for printing closures 131 of closed containers 130. The device comprises a transport section 101 in which the closed containers 130 are transported along a transport direction (arrow). Thus the transport section defines a transport direction for the containers 130. The transport section may be configured as a conveyor belt. Other embodiments, for example transportation of the containers on stands, are also conceivable. The transport section need not be made linear, but may also be provided as a part of a machine configured as a rotary machine with a plurality of container holders.

The device 100 can be part of a container treatment system for treating containers. In addition to the device 100, the container treatment system can comprise further container treatment machines, in particular a filler, a closer, and a labeling machine. All of these container treatment machines may be arranged upstream of the device 100. However, one or more may also be provided downstream of the device. If the device is integrated into such a container treatment system, it is preferred that not only the closer, but also a labeling machine or printing machine for labeling/printing the container are arranged upstream of the device.

A detection unit 102 is arranged in the area of the transport section 101. This detection unit is arranged such that it can determine at least the position of the closure 131 of each container 130 transversely with respect to the transport direction. The detection unit 102 may for example be configured as a 2-D, 3-D or line scan camera and arranged above the transport section 101, with the optical unit of the camera pointing in the direction of the transport section. The distance between the detection unit and the transport section is here chosen such that closed containers 130 can be transported in the transport section 101 underneath and beyond the camera. The detection unit does not have to be configured as a camera, but is at any rate configured such that it can determine the position of the closure transversely with respect to the transport direction. This means that the detection unit can determine how the closure is positioned on the container relative to a reference, for example the center of the transport section 101.

A printing unit 103 which can print the closure 131 of a container 130 conveyed in the transport section 101 is arranged in transport direction after the detection unit 102. For this purpose the printing unit 103 can for example be configured as a digital printing head, in particular as an inkjet printing head, and apply printing ink to the closure 131. Preferred are all digitally controllable contactless printing methods, in particular drop-on-demand methods and corresponding printing heads.

The printing ink is here applied such that a predetermined print image is created on the closure 131. It goes without saying that further printing units may be provided in transport direction one after the other. Specifically, each printing unit can be configured to eject printing ink with a different color, so that a multicolored image can be produced by using several printing units.

A control unit 105 is assigned to the detection unit 102 and to the printing unit 103. On the one hand, this control unit receives a signal of the detection unit 102 that is indicative of the position of a closure 131 in a direction transverse and also longitudinal or parallel to the transport direction. This signal can for example be indicative of the distance of the center point of the closure from the center of the transport section 101. This signal is used by the control unit 105 to control the printing unit 103 such that it ejects printing ink in response to the signal, so that the printing ink is applied to the closure 131 and a print image is produced on the closure.

It is particularly preferred when the printing unit 103 is configured for this purpose as a digital printing unit and is further arranged in a stationary manner in relation to the transport section 101. To be able to provide closures 131 with a print image, the position of which is different with respect to the center of the transport section 101 or any other reference, the printing unit may comprise a printing head with a printing area which extends transversely to the transport direction in an area greater than the diameter of the closure. It is particularly preferred when the printing area transverse to the transport direction has the same width as the transport section 101. Thus, not only deviations in the shape of the container and thus the position of the closure with respect to the ideal shape can be taken into consideration, but also deviations in the position of the containers themselves in the case of a disordered transport of the containers in the transport section.

Furthermore, a further detection unit 104 which determines the position of the containers in transport direction can be arranged along the transport section 101. In combination with the detection unit 102, this unit can also be used advantageously to determine the position of the closure not only transversely to the transport direction, but also in transport direction more accurately, especially in relation to the container. The further detection unit 104 can here be configured for example as a light barrier which detects the passage of a specific point of the transport section through a container. This further detection unit 104 can also be connected to the control unit 105 and transfer to said unit a signal indicative of the position of the containers along the transport section. In addition to the signal of the detection unit 102 which is used for the control of the printing unit 103, the control unit 105 can also use this signal.

To improve the quality of the print image applied to the closure, it may be provided that a treatment unit for treating the container or at least the closure is arranged upstream of the device or at least upstream of the printing unit 103. This treatment unit may be a pyrolysis device, plasma coating device or corona treatment device. The closures can be treated with such a treatment unit also before the application of the closures to the containers, so that the treatment unit may be provided in a closer which is arranged upstream of the device 100. With the treatment the surface of the closure is preferably treated such that it is better wettable with the printing ink than the untreated surface of the closure. The adhesion of the printing ink to the surface should also be improved by the treatment of the surface as compared to the untreated surface. This can for example be achieved in that the surface tension of the surface to be printed is reduced or increased to a specific value by the treatment of the closure.

If the device 100 is integrated into a container treatment system comprising a labeling machine, the treatment unit is preferably arranged downstream of the labeling machine and upstream of the device 100.

Furthermore, a drying or aftertreatment device which dries or treats the applied printing ink on the closure can be arranged downstream of the device 100 or at least downstream of the printing unit 103. To this end a UV tunnel or infrared tunnel may be provided with one or more corresponding radiation sources. Alternatively, individual ones of said radiation sources may also be arranged after the printing unit 103 in the area of the transport section.

The containers do not have to be transported in the treatment unit in one lane. A transport device which guides the containers along or through the treatment unit may also be configured as a mass transporter.

FIGS. 2a and 2b show the deviation of an actual container 130, which is to be printed and closed, from an ideal shape 230 in an exaggerated manner. For this purpose FIG. 2a shows a side view of a corresponding container 130 in the transport section 101. In the ideal case which cannot always be achieved during production, the container 230 is a body which is substantially rotation-symmetrical about an axis L. For example embodiments of the containers as bottles, in particular glass bottles or PET bottles, are here considered. It should be noted that also non-rotation-symmetrical containers may have a shape differing from an imaginary ideal shape. The following discussion, however, starts from a container whose ideal shape is rotation-symmetrical relative to the axis L. However, all methods and devices that are here described can also be applied to containers having an assigned ideal shape that is not rotation-symmetrical.

In addition, the method offers the possibility of freely conveying the containers on the belt without the need for positioning guide elements such as railings for guiding the containers with millimeter precision or for belt pairs to take over the centering of the container relative to the printing head. This entails the advantage that changeover work during production changeover from one container shape to another container shape can largely be avoided.

With an ideal shape of the container 230 the axis L and the center point of the closure 231 coincide. Moreover, in the case of an ideal transport of the container 230 in the transport section 103 the center line of the transport section forms a plane with the axis L, which plane is perpendicular to the transport section. This ideal case refers to transport sections whose transport surfaces, on which the containers are positioned during transport, are exactly located in the horizontal. With transport surfaces inclined relative to the horizontal, the above implementations can however be transferred directly to the ideal transport of the containers provided for this. Particular mention should here be made of the angle which the axis L encloses with the horizontal. With an ideal transport of ideal containers along an inclined transport section the angle L of each container always encloses the same angle with the horizontal or vertical.

However, since in the production of the containers, in particular in the case of glass bottles and PET bottles, the materials are exposed to stress (uneven cooling, deformation, solidification, crystallization, filling, closing, manufacturing tolerances and the like), not every container will have the ideal shape 230, so that the closure 131 of the container 130 during transport along the transport section normally has a position differing from the ideal position 231. A common manufacturing tolerance of a 0.71 bottle of PET or glass is normally about 1.8 mm in diameter. With a closure having a diameter of 30 mm, this results in a corresponding demand on accuracy in x- and in y-direction. Furthermore, when the containers are transported with a play within the transport section 103, the whole position of the container may further differ from the ideal position 230.

The deviation of the actual position of the closure 131 as compared with the ideal position 231 is shown in FIG. 2b. The position of the closure 131 of the container 130 in the transport section 101 is here shown with reference to the detection unit 102 which determines the position of the closure 131. FIG. 2b is a top view made through the detection unit 102 on the transport section and on the container 130 contained therein. It can be assumed in good approximation that the position of the closure or the container on the transport belt 131 does not change between the detection unit 102 and the printing unit 103, so that the position of the closure 131 determined by the detection unit 102 can be used to control the printing unit. Preferably, the printing head is located in the direct vicinity of the detection unit on the same belt section, but not more than 1 m away. It may be advantageous if the belt section between the detection unit and the printing unit extends in a straight line and the containers are not subjected to acceleration at least in this belt section. It can thereby be prevented that the containers move from the detection unit up to the printing unit, i.e. slip on the transport belt.

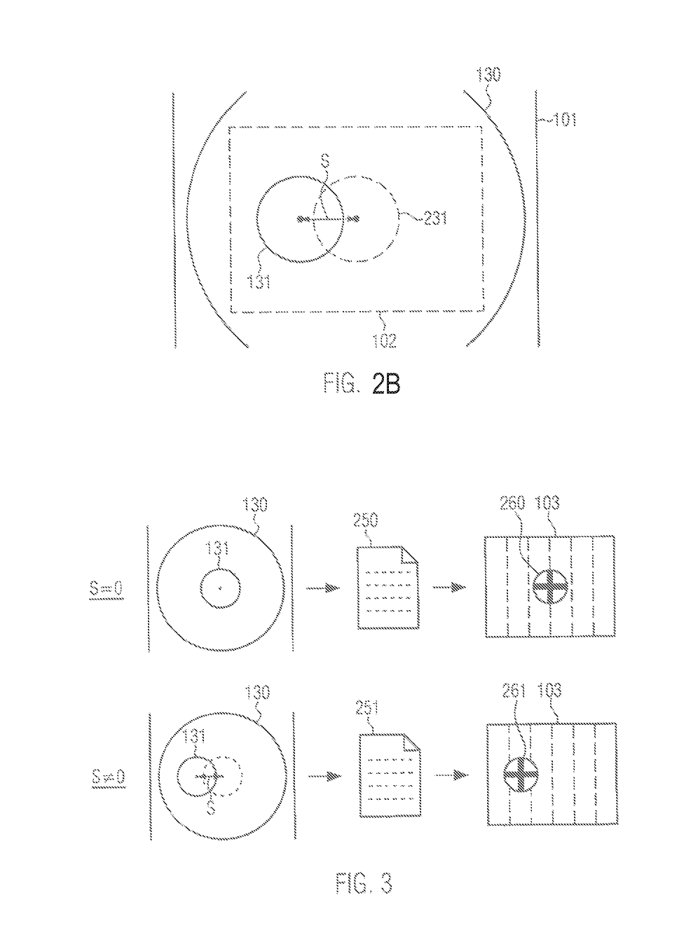

FIG. 3 shows a corresponding method for this. First of all, the case s=0 shall be discussed. In this case the position of the closure 131 corresponds to the ideal position of the closure described with reference to FIGS. 2a and 2b. For this ideal position, the control unit may contain a print image 250 in a memory assigned to it. This print image, which can for example be stored in a file, has assigned thereto further information allowing a control of the printing unit for ejecting the printing ink. This additional information refers in particular to position specifications of the print image to be applied to the closure in relation to the printing unit 103. This also includes information allowing a control of the individual nozzles of a printing unit configured for example as a digital printing unit. At an ideal position of the closure (s=0) the print image 250 stored in the memory can be used together with the additional information by the control unit to control the printing unit 103. Here, the stored print image corresponds to the print image 260 to be applied to the containers with respect to its intended position.

In the case s≠0 which usually occurs during production, the use of the print image 250 to be applied according to FIG. 2a would mean a print image of poorer quality which for example would not be correctly positioned with respect to the center of the closure or would not be completely printed on the container. On the basis of the signal which is output by the detection unit and which is indicative of the actual position of the closure 131 transversely to the transport direction and thus of the deviation s from the ideal position, the control unit can modify the print image 250 stored in the memory and produce a print image 251 to be applied to the closure 131. Preferably, this is completely done on a software basis. Hence, this means that the original print image 250 is only digitally modified using for example a computer or a processor or similar devices. In particular, the information which is further assigned to the print image and allows a control of the printing unit and particularly of individual printing nozzles is changed based on the signal received from the detection unit. The print image which is thereby obtained and is to be applied is then used for controlling the printing unit 103 which instead of the print image 260 applies the print image 261 to the closure of the container. When a 3-D camera is used, z-information may also be transmitted to the printing head to compensate for container height differences as occur in the processing of reusable PET. The use of the depth information is particularly advantageous if the closures to be printed comprise indentations or elevations, for example a relief.

Instead of changing the position of the printing unit or a printing head mechanically, the control of the printing unit is thereby changed just digitally so that the print image or printing ink is applied depending on the actual position of the closure 131. This can be done much faster than a mechanical positional change of the printing unit, so that the throughput of containers can be very high.

The change in the position of the print image, which is applied by the printing unit 103, and, in the final analysis, is defined by the print image to be applied or the file 251 representative thereof for the control of the printing unit, can also be made with respect to the position of the closure in the direction of the transport section on the basis of a corresponding signal of the detection unit 102, but also the detection unit 104. For this purpose a two-dimensional or three-dimensional coordinate system, in particular a Cartesian coordinate system, can be used within the control unit 105. Transformations of the print image for producing/obtaining the print image to be applied can then be made in this coordinate system by coordinate transformation of the pixels of the print image. For the control of the printing unit or the printing nozzles of this printing unit the same coordinate system or a coordinate system connected to the coordinate system by a known transformation can be used.

The transfer of the x-, y-, z-rotational positions or contour information can take place via a rotary encoder and a controlled or tracked coordinate transfer to the printing module.

The embodiment as has been described with reference to FIG. 3 allows an adaptation of the print image or printing ink applied by the printing unit to translational changes in the position of the print image. This means that the actual position of the closure 131 results from a shift of the ideal position of the closure, as has been depicted in FIGS. 2a and 2b.

In some applications, however, it may be necessary to consider not only this shift, but also rotations of the container in relation to its ideal orientation along the transport section.

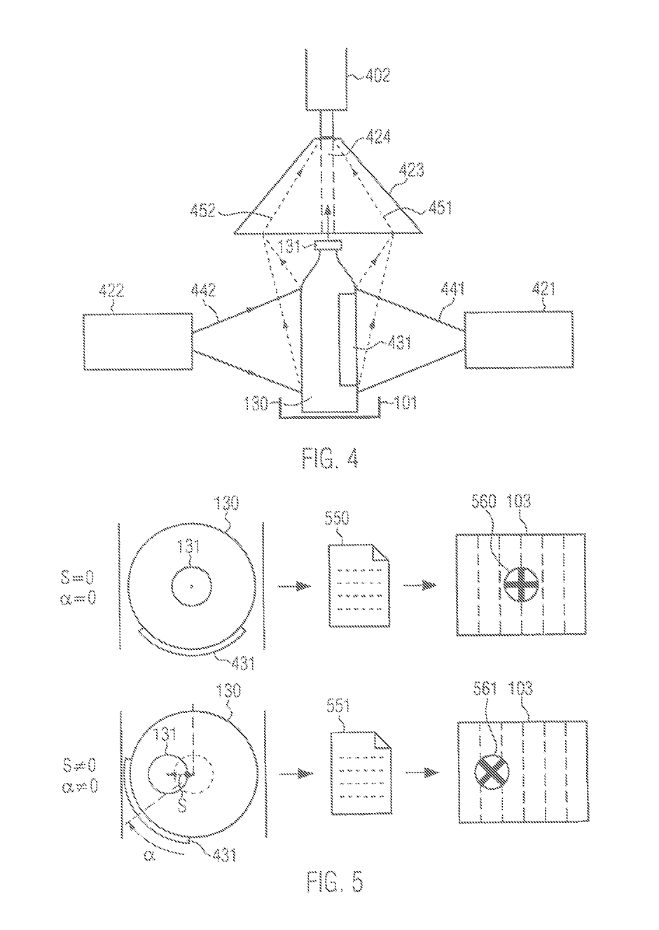

This embodiment is described with reference to FIGS. 4 and 5. FIG. 4 shows a container 130 in the transport section 101 which, apart from the closure 131, also comprises a label 431. This label can be applied at least to a part of the outer surface of the container 130. With the embodiment depicted in FIGS. 4 and 5, not only a print image corresponding to the position of the closure relative to the ideal position is applied, but simultaneously a print image correctly oriented with respect to the label. For this purpose at least one illumination device 421 and/or 422 which can illuminate the container 130 at least in an area comprising the label 431 is further provided in the device. For this purpose the illumination device can for example emit light in the visible range (441 and 442). This light is reflected from the surface of the container and from the label, namely into the dashed directions 451 and 452, respectively, indicated by the arrow.

In this embodiment, it is further provided that an optical body 423 is assigned to the detection unit 402, which comprises a corresponding optical unit for picking up light and may, for example, be configured as a camera. The optical body 423 is arranged in such a way that at least a part of the light 451 and 452 reflected from the container passes therethrough or penetrates it. Furthermore, the optical body is configured in such a way that by reflection and/or refraction of the light 451 and 452, respectively, it diverts said light in such a way that it impinges on the optical unit of the detection unit and can be detected there. The detected reflected light 451 and 452, respectively, can then be used to determine the position of the label on the container and thus its relative orientation in the transport section 101. For example, this relative orientation can be determined with reference to a reference value. The reference value can be selected so that the center point of the label lies on an ideally positioned container in a plane perpendicular to the transport section, which runs through the center line of the transport section. Furthermore, this reference value may correspond to the case where the label points in transport direction of the container.

In order not to influence, if possible, the determination of the position of the closure 131 by optical effects of the optical body 423, the optical body may comprise an opening or aperture 424 whose center point or longitudinal axis lies on the optical axis of the optical unit of the detection unit. The opening can be dimensioned in such a way that, if possible, all of the possibly occurring shifts of the closure 131 transversely to the transport direction can be detected by the optical unit through the opening. For example, the opening can have a diameter of 4 cm. Other diameters are also conceivable here. The edge of the optical body, which limits the aperture 424, can be used in an advantageous way, for example in order to support the reflection or refraction of the light reflected from the container into the optical unit.

While this embodiment has been described with reference to a label applied to the container, other applications are also conceivable. Basically, this embodiment is suitable for printing the closure with regard to any orientation predetermined by a feature of the container and/or closure. For example, the print image can also be applied to the closure depending on a geometrical feature of the container or the closure and its orientation in relation to a reference orientation or ideal orientation. Geometrical features include, for example, certain shapes such as edges of the closure or curvatures or notches of the container at a certain point of the container. Basically, these features are symmetry-breaking features that define a certain preferential direction.

While in the above and the following description reference is made to a specific orientation predetermined by the label, all embodiments can also be applied to other features of the container or closure if these features require a specific orientation of the print image on the closure.

By analogy with the method described in FIG. 3, the printing unit can also be controlled in this embodiment depending on the position and orientation of the container or closure determined by the detection unit.

This is schematically illustrated in FIG. 5. First of all, the case s=0 and α=0 is discussed. α corresponds to the angle by which the label is rotated with respect to any desired, but fixed reference. This is equal to a rotation of the container with the label to said reference. In the embodiment shown in FIG. 5, the center line of the transport section is used as the reference. Correspondence between the reference and the orientation of the container means here that the center point of the label lies on the center line of the transport section and the label points in transport direction of the container. However, if an imaginary line of the rotation axis of the container through the center point of the label, with this line extending parallel to the plane in which the containers are transported, encloses an angle α different from zero with the center line, the orientation of the container does not match the reference. Any other reference value may also serve as reference.

In the case that the container 120 with the label is oriented or rotated exactly as provided by the ideal position, the print image 550 stored in the memory can be used by the control unit as the print image 560 to be applied. The information stored in addition to the print image with respect to the control of the printing unit 103, particularly the printing nozzles, can be used to eject the printing ink in the end such that the print image 560 is applied to the closure 131 at the position shown in FIG. 5.

In the case that α=0 and s≠0, i.e. the container is not rotated with respect to the reference, but the closure is shifted, the method according to FIG. 3 can be used to consider the position of the closure in the control of the printing unit.

In the general case that α=0 and s≠0, the print image stored in the memory of the control unit is modified on the one hand by analogy with FIG. 3 to control the printing unit depending on the shift of the closure 131 with respect to the reference position. On the other hand, the print image stored in the memory is modified depending on the angle α by which the label 431 is rotated with respect to the reference position. To this end the print image is rotated digitally or on the basis of software, so that the orientation of the print image corresponds to the orientation of the label on the container to be printed. If the angle α is for example 25°, the print image stored in the memory is also rotated by 25° in the same direction. Both transformations of the print image stored in the memory can here be carried out simultaneously or one after the other on the print image to determine the print image to be applied. Specifically, it is here possible to apply the known laws of affine transformation in two dimensions.

Generally, it is true for the software-based adaptation of the print image in the memory in the case of a closure shifted with respect to the ideal position and simultaneous rotation of the container that any point \vec{x} of the print image to be applied can be determined from the coordinates of the original point \vec{p} according to

\vec{x}=A\vec{p}+\vec{s}

where A is the rotation matrix in the two-dimensional Cartesian space (using the rotational angle α by which the container is rotated with respect to the reference) and \vec{s} is the shift vector according to the shift s. Without loss of generality it is here assumed that the center point of the coordinate system as used here lies in the center point of the print image (central affine map). If for the determination of the print image to be imprinted only the shift of the closure transversely to the transport direction is taken into consideration, the component of the vector \vec{s} parallel to the transport direction of the container is always 0.

This calculation can be carried out for every original pixel of the print image stored in the memory and thus the print image to be applied can be determined for a closure or container shifted and rotated in any desired manner with respect to the ideal position. This transformation can for example be carried out even more effectively by a processor of the control unit (for example a graphics processor) optimized for parallel computing. However, also the processors generally used for control in control units can be used for this since floating point numbers are concerned in the final analysis.

The embodiment depicted in FIG. 4 is also suitable for printing closures of containers that have already been fed to a distribution center in a container treatment system. Such a distribution center may contain many, also different, containers. Since the device according to the embodiment depicted in FIG. 4 can ultimately detect not only the position but also the contents of the label, the printing unit can be controlled not only in such a way that the position and orientation of the print image to be applied to the closure is adapted to the position of the closure, but also the print image itself can be selected software-based on the basis of the information obtained about orientation, contents and size of the label.

1. A device for printing closures of closed containers, comprising a transport section for transporting the containers, wherein a detection unit and a printing unit for printing a closure of a container are arranged one behind the other in transport direction, wherein the detection unit can individually determine the position of the closure transversely with respect to the transport direction for each container and can transmit a signal indicative of the position to a control unit which is assigned to the detection unit and the printing unit, wherein the control unit is configured to control the printing unit to apply printing ink to the closure in order to print the closure, depending on the position.

2. The device according to claim 1, wherein the control unit for controlling ejection of the printing ink is configured to adapt a print image stored in a memory for the closure on the basis of software to the position to obtain a print image to be applied and to control the printing unit based on the print image to be applied for the ejection of the printing ink.

3. The device according to claim 1, wherein the printing unit is a digital printing unit and comprises a printing area whose width transverse to the transport direction is greater than the diameter of a closure to be printed and at most equal to the width of the transport section.

4. The device according to claim 1, wherein the printing unit is arranged in a stationary manner.

5. The device according to claim 1, wherein the detection unit comprises an optical unit for taking an image, an illumination device for illuminating at least a part of the container transported in the transport section and an optical body assigned to the optical unit for diverting rays of the illumination device reflected from the container into the optical unit.

6. The device according to claim 5, wherein the illumination device can emit light in the visible range and the optical body has a refractive index greater than 1 or consists of reflective material.

7. The device according to claim 5, wherein the optical body is arranged concentrically to the optical unit and comprises an aperture whose center point lies on an optical axis of the optical unit.

8. The device according to claim 5, wherein the control unit is configured to rotate a print image stored in a memory for the closure on the basis of software, depending on the reflected light, to produce a print image to be applied depending on the position of the label on the container and to control the printing unit on the basis of the print image to be applied for the ejection of the printing ink.

9. A method for printing closures of closed containers comprising: transporting the containers along a transport section; determining, via a detection unit, position of the closure transversely with respect to the transport direction for each container; and applying, via a printing unit, printing ink for producing a print image to the closure, wherein ejection of the printing ink is controlled by a control unit on the basis of a signal which is output by the detection unit and is indicative of the position of the closure transversely with respect to the transport direction.

10. The method according to claim 9, wherein the position is optically determined by the detection unit.

11. The method according to claim 9, wherein the containers are transported in a disordered manner at least with respect to their position transversely to the transport section.

12. The method according to claim 9, wherein for the control of the ejection of the printing ink, a print image stored in a memory for the closure is adapted on the basis of software to the position to obtain a print image to be applied and the printing unit is controlled on the basis of the print image to be applied for the ejection of the printing ink.

13. The method according to claim 9, wherein the closed containers to be printed comprise a label, the method further comprising illuminating, via an illumination device, the containers at least in an area which comprises at least a part of the label; and supplying light reflected from the area through an optical body to an optical unit of the detection unit.

14. The method according to claim 13, wherein the detection unit is controlled by the control unit on the basis of the reflected light supplied to the detection unit for the ejection of the printing ink.

15. The method according to claim 13, further comprising, software-based rotating a print image for the closure, which is stored in a memory of the control unit, depending on the reflected light, to produce a print image to be applied depending on the position of the label on the container, and controlling the printing unit based on the print image to be applied for the ejection of the printing ink.
